(19) United States
(12) Patent Application Publication
(10) Pub. No.: US 2003/0220856 A1
(43) Pub. Date: Nov. 27, 2003

(54) System and method for specifying a financial transaction

(76) Inventors: Afshin Bayrooti, Tuckahoe, NY (US); Bruce Broder, West Hempstead, NY (US); Jean-Francois Christory, New York, NY (US)

Correspondence Address: Christopher J. Gaspar, Esq., Milbank, Tweed, Hadley & McCloy LLP, One Chase Manhattan Plaza, New York, NY, 10005, US

(21) Appl. No.: 10/153,386

(22) Filed: May 22, 2002

(51) Int. Cl. G06F 17/60

(52) U.S. Cl. 705/35

(57) ABSTRACT

In one aspect, the present invention relates to systems and methods for providing information about a financial transaction to a number of functional units of a financial institution. In another aspect, the present invention relates to systems and methods for accessing a computer system with a visual editor to create a specification for a financial transaction, and to interface the specification with a pricing tool to model allocation of cash flows to accounts.

### BACKGROUND

I. Field of the Invention

The present invention relates to systems and methods for providing information about a financial transaction, and more particularly, to systems and methods for specifying the structure of a financial transaction.

II. Description of the Related Art

The price of certain securities issued by a particular financial institution may be based on the value and/or payout of a number of different instruments such as stocks, bonds, pools of loans, options, collateralized bond obligations, and other asset classes at a particular state of the world. For example, an instrument may generate income if certain states of the world actually transpire, and cash flows generated from one or more instruments upon which a particular security is based may then need to be allocated to one or more accounts. The allocation of such cash flows are often specified by a somewhat lengthy contract which memorializes the terms of an underlying financial transaction or deal.

In some conventional systems and methods, a spreadsheet containing dependency tables may be used to compute and/or model the allocation of cash flows to an appropriate account according to a set of rules specified in the contract. However, certain users of these conventional systems and methods may have difficulty tracing through the dependency tables (which may or may not have explanatory documentation) in order to ascertain a particular cash flow allocation for one or more state(s) of the world.

In addition, information about a particular deal may need to be provided to a variety of different users or groups within the financial institution, such as attorneys, marketing personnel, trustees, and risk management personnel. For example, a financial institution's attorneys may need to create a legal document describing the terms of the deal. The institution's marketing unit may need to determine the price of a security based on the financial transaction. The trustee for the institution may need to determine how to allocate income based on a particular set of events, while a risk management group may be tasked with evaluating the potential performance of the security depending upon a variety of potential states of the world. Using conventional systems and methods, a particular financial institution may have difficulty easily providing substantially identical information about a particular deal to several business units within the institution in a format that is useful for each business unit.

### SUMMARY OF THE INVENTION

In one aspect, the invention features a method of providing information about a financial transaction to a plurality of functional units of a financial institution, the method including assembling a specification for the financial transaction, the assembling step including obtaining data descriptive of a transaction template from an electronic storage medium, the electronic storage medium containing data descriptive of a plurality of predefined transaction templates, each of the transaction templates having a sequential list of instructions, at least one of the instructions including a financial transaction term in a contractual style grammar, and each of the instructions having a variable corresponding to an account. In accordance with this aspect of the invention, the assembling step also includes using a computer system to perform at least one of the following group of actions: removing at least one of the instructions from the sequential list; adding an instruction to the sequential list; and modifying at least one of the instructions. The method of providing information about a financial transaction according to this aspect further includes generating, based on the specification, a plurality of operable tools, each of the tools adapted for use by a different functional unit of the plurality of functional units of the financial institution.

In another aspect, the invention features a system for providing information about a financial transaction to a plurality of functional units of a financial institution, the system including a storage medium containing data descriptive of a plurality of predefined transaction templates, each of the transaction templates having a sequential list of instructions, at least one of the instructions including a financial transaction term in a contractual style grammar, and each of the instructions having a variable corresponding to an account. In accordance with this aspect of the invention, the system also includes a processor in communication with the storage medium, the processor configured to assemble a specification for the financial transaction by obtaining data descriptive of a transaction template from the storage medium and performing at least one of the following group of actions: removing at least one of the instructions from the sequential list; adding an instruction to the sequential list; and modifying at least one of the instructions. The processor according to this aspect is further configured to generate, based on the specification, a plurality of operable tools, each of the tools for use by a different functional unit of the plurality of functional units of the financial institution.

In a further aspect, the invention features a system for providing information about a financial transaction, the system including means for assembling a specification for the financial transaction, the means for assembling having means for obtaining data descriptive of a transaction template from an electronic storage medium, the electronic storage medium containing data descriptive of a plurality of pre-defined transaction templates, each of the transaction templates having a sequential list of instructions, at least one of the instructions including a financial term in a contractual style grammar, and each of the instructions having a variable corresponding to an account. In accordance with this aspect of the invention, the system also includes means for performing at least one of the following group of actions: removing at least one of the instructions from the sequential list; adding an instruction to the sequential list; and modifying at least one of the instructions. The system according to this aspect further includes means for generating, based on the specification, a plurality of operable tools, each of the tools adapted for use by a different functional unit of the plurality of functional units of the financial institution.

In yet another aspect, the invention features a method including accessing a computer system having a visual editor, using the visual editor to create a specification for a financial transaction, the specification having a list of instructions representing a plurality of rules defining an allocation of a plurality of cash flows from an asset portfolio to a plurality of accounts, each instruction created using a contractual style grammar. In accordance with this aspect of the invention, the method further includes interfacing the specification with a pricing tool to model the allocation of the plurality of cash flows to the plurality of accounts.

In a further aspect, the invention features a system including a visual editor; and a processor in communication with the visual editor, the processor configured to create a specification for a financial transaction, the specification having a list of instructions representing a plurality of rules defining an allocation of a plurality of cash flows from an asset portfolio to a plurality of accounts, each instruction created using a contractual style grammar. In accordance with this aspect of the invention, the processor is further configured to interface the specification with a pricing tool to model the allocation of the plurality of cash flows to the plurality of accounts.

In another aspect, the invention features a system including means for accessing a computer system having a visual editor, means for using the visual editor to create a specification for a financial transaction, the specification having a list of instructions representing a plurality of rules defining an allocation of a plurality of cash flows from an asset portfolio to a plurality of accounts, each instruction created using a contractual style grammar, and means for interfacing the specification with a pricing tool to model the allocation of the plurality of cash flows to the plurality of accounts.

### BRIEF DESCRIPTION OF THE DRAWINGS

The foregoing features and other aspects of the invention are explained in the following description taken in conjunction with the accompanying drawings, wherein:

FIG. 1 illustrates a system 10 according to one embodiment of the present invention;

FIG. 2 illustrates certain components of a local computer 100 of the system 10 shown in FIG. 1;

FIG. 3 illustrates an exemplary portion of a transaction editor 182 page generated by a visual editor 180 of one embodiment and as displayed by an output device (e.g., computer monitor or screen) 140 of a local computer 100 of the type shown in FIG. 2;

FIG. 4 illustrates an exemplary portion of a variables editor 184 page generated by a visual editor 180 of one embodiment and as displayed by an output device (e.g., computer monitor or screen) 140 of a local computer 100 of the type shown in FIG. 2;

FIG. 5 illustrates an exemplary portion of a scratch pad 186 page generated by a visual editor 180 of one embodiment and as displayed by an output device (e.g., computer monitor or screen) 140 of a local computer 100 of the type shown in FIG. 2;

FIG. 6 illustrates an exemplary portion of a configuration manager 188 page generated by a visual editor 180 of one embodiment and as displayed by an output device (e.g., computer monitor or screen) 140 of a local computer 100 of the type shown in FIG. 2;

FIG. 7 illustrates certain components of a simulation computer 300 of the system 10 shown in FIG. 1;

FIGS. 8a-8c illustrate a method of creating a specification using the system 10 shown in FIG. 1;

FIG. 9 illustrates a table of operator preference and associativity as implemented in a compiler 162 of one embodiment of the system 10 shown in FIG. 1; and

FIG. 10 illustrates a method of providing information about a financial transaction using the system 10 shown in FIG. 1.

It is to be understood that the drawings are exemplary, and are not limiting.

### DETAILED DESCRIPTION OF PREFERRED EMBODIMENTS

Various embodiments of the present invention will now be described in greater detail with reference to the drawings.

I. System Embodiments of the Invention

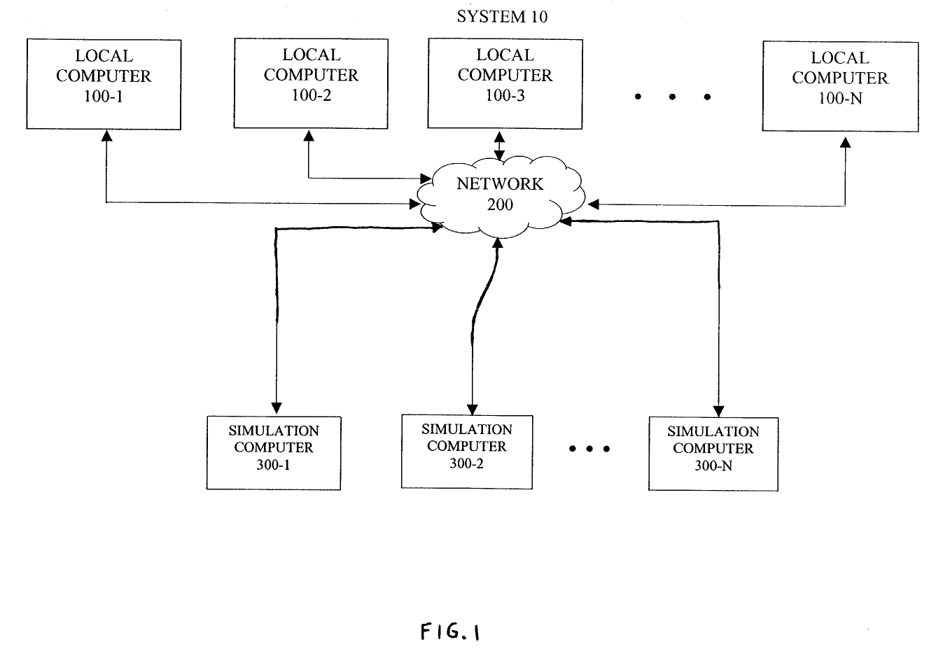

FIG. 1 illustrates certain components of one embodiment of a system 10 of the present invention, which generally includes one or more local computers 100-1 to 100-N in communication, via a network 200, with each other and with one or more simulation computers 300-1 to 300-N.

A. Local Computer 100

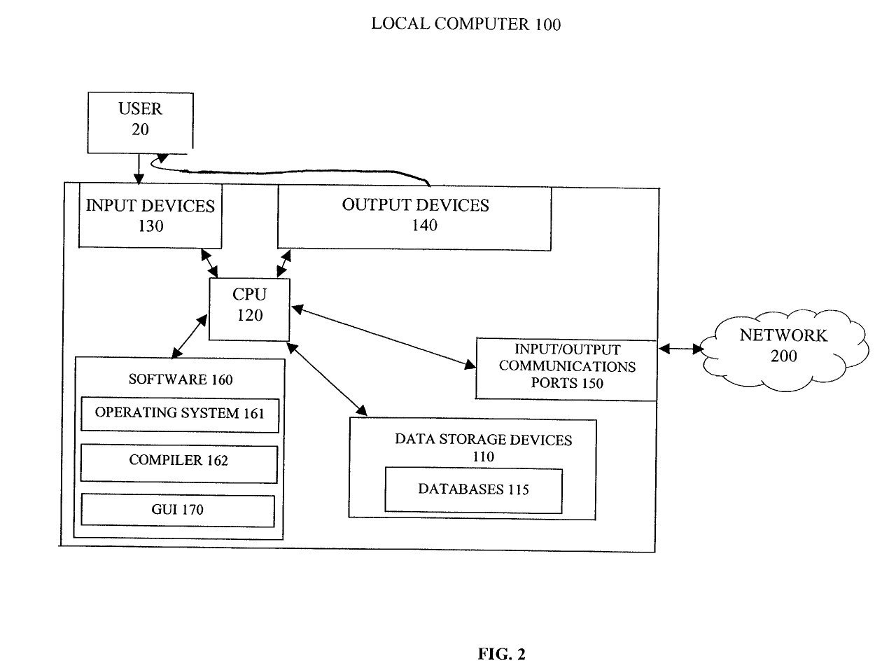

In the embodiment depicted in FIGS. 1 and 2, each local computer 100 generally includes one or more data storage devices 110, having one or more databases 115 defined therein, a central processing unit (CPU) 120, one or more input devices 130, one or more output devices 140, input/output (I/O) communications ports 150, and other hardware components (not shown) which facilitate performance of the functions of the system 10 as described herein. In one embodiment, the hardware devices of a local computer 100 are in communication with one another by a shared data bus and/or by dedicated connections (not shown). In addition, a number of software components 160 reside and run on each local computer 100.

A data storage device 110 of one embodiment include one or more hard disk drives. However, it is to be understood that data storage devices 110 such as RAM, ROM, CD-ROM, DVD-ROM, floppy disk-drive or combinations thereof may also be included in the embodiment shown in FIG. 2, or in certain other appropriate embodiments. The input device(s) 130 (e.g., keyboard, pointing/selecting device such as a mouse, touch pad or track ball, floppy disk-drive, scanner and/or touch screen interface) enable a user 20 of the system 10 to provide information and instructions for storage in the local computer 100 and use in operation of the system 10. The output devices 140 (e.g., printer, display device, floppy disk-drive and/or computer monitor) enable a user 20 to receive, for further manipulation and/or storage, information generated using the system 10. The I/O communications ports 150 are serial and parallel, and are configured to include multiple communications channels for simultaneous connections. The software components 160 of one embodiment may include an operating system 161 (e.g., Linux, Unix, or Microsoft Windows NT), a compiler 162, and graphical user interfaces (GUI) 170 including a visual editor 180 and a pricing tool interface 190. In one embodiment, a local computer 100 is a personal computer. However, the local computers 100-1 to 100-N in accordance with embodiments of the system 10 need not be identical, and need not be personal computers.

In one embodiment, each local computer 100 includes a graphical user interface (GUI) 170. In such an embodiment, a user 20 may interact with the GUI 170 to create, price, save, and/or edit a sequential list of statements or expressions which collectively specify, represent or model a particular instrument. Such a sequential list of statements or expressions, referred to herein as a “specification” 155, may include the rules according to which cash flows resulting from one or more instruments are to be allocated to one or more accounts.

As one example of a financial transaction for which a specification 155 may be created, consider a pool of loans paying cash flows that are to be distributed to a number of people at particular times or upon the occurrence of particular events. In some cases, such a financial transaction may be described in a lengthy document or contract, which may be difficult to review and understand quickly. Using one embodiment of a system 10 according to the present invention, a user 20 can describe a relatively complex financial transaction using a contractual style grammar that is a variant of a common language. In one embodiment, the contractual style grammar is a variant of the English language. An example statement written in a contractual style grammar and including a financial transaction term according to one embodiment may be “Transfer 0.05*cashflows from Account1 to Account2.” The payout for a particular instrument may be modeled using the specification 155, which describes the allocation rules for the instrument in a way such that the instrument can automatically be implemented in computer code and linked with a pricing tool 380 (e.g., a Monte Carlo simulation) to compute the cash flow allocations based on different states of the world. In such an example, a “state of the world” may include the date, the names of loans in default, and the values for particular indices. The current state of the world may also include historical information that the instrument can access and set, thereby handling path dependencies.

In one embodiment of the system 10, a library of instruments each represented by a specification 155 that has been implemented in software (e.g., C++ code for computing the instrument's payout when provided with conditions representing a particular state of the world) may be stored, e.g., in a database 115 of a local computer 100, in a database 315 of a simulation computer 300, and/or in another type of data storage device such as a server or storage area network (not shown) in communication with one or more of the local computers 100 and/or simulation computers 300. The pricing tool 380 may repeatedly sample the computer software representation of an instrument (i.e., the specification 155) by setting up different states of the world, collecting the payout of the instrument, and combining the payouts to produce a price. The system 10 of one embodiment of the present invention allows a user 20 to use a specification 155 for one or more instruments in connection with the pricing tool 380 without writing computer code in a programming language, such as C++. Such a system 10 then may be used to model cash flows of a variety of instruments, including, e.g., stocks, bonds, pools of loans, options, collateralized bond obligations and other asset classes being securitized.

The system 10 of one embodiment uses software including a compiler 162, a visual editor 180, a pricing tool interface 190, and a pricing tool 380 to perform various functions as described herein. In one embodiment, the visual editor 180 is part of a GUI 170 displayed on an output device (e.g., computer monitor or screen) 140 of a local computer 100. Such a visual editor 180 functions, among other things, to guide a user 20 in creating the specification 155 of an instrument in conformity with a contractual style grammar. The compiler 162 of one embodiment generates a programming language representation of an instrument based on the specification 155 while the pricing tool interface 190 allows a user 20 to select an instrument, price the instrument, and provide detailed diagnostics to allow the user 20 to debug the instrument. In this embodiment, the pricing tool 380 simulates different states of the world, calculates the payout for the instrument, and combines the payouts of all relevant instruments to provide a value or price for a contract.

B. Visual Editor 180

In one embodiment, a visual editor 180 is a software application created in a C programming language to run on a local computer 100 in order to guide a user 20 in creating, modifying, compiling, debugging and/or storing the specification 155 of an instrument or financial transaction. The visual editor 180 of such an embodiment includes a transaction editor 182, a variables editor 184, a scratch pad 186 and a configuration manager 188. Moreover, one embodiment of the visual editor 180 is in communication with a pricing tool interface 190 and pricing tool 380 software residing in whole or in part on at least one simulation computer 300.

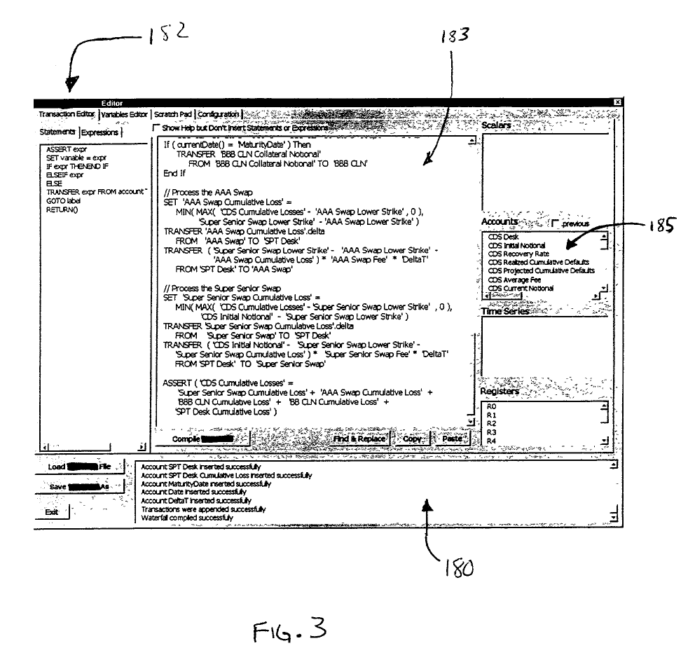

FIG. 3 depicts a portion of a transaction editor 182 page generated by the visual editor 180 of one embodiment of the present invention. A user 20 may interact with such a transaction editor 182 to build a specification 155. The center panel 183 shows the list of statements written in a contractual style grammar that define a particular instrument or financial transaction.

In one embodiment, variables 185 are displayed in a panel toward the right side of the transaction editor 182 page, and statements and expressions written in a contractual style language are displayed in a panel toward the left side of the page.

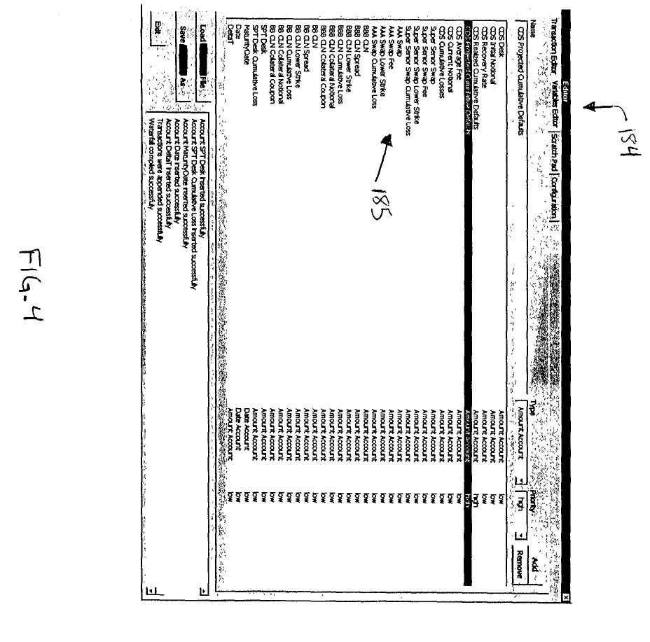

FIG. 4 depicts a portion of a variables editor 184 page generated by the visual editor 180 of one embodiment of the present invention. A user 20 may interact with such a variables editor 184 to define and store variables 185 for incorporation into a specification 155. In accordance with one embodiment, there may be several types of variables 185, including scalars, accounts and time series, each of which may be displayed on the variables editor 184 page. A scalar variable 185 contains a value at a current state of the world, but does not retain its value computed for previous states of the world. An account variable 185 retains its value at the state of the world immediately preceding the current state of the world, as well as its value at the current state of the world. A time series variable 185 retains all of its previous values and its current value. For example, a previous value for a time series variable 185 may be displayed by an array operator (e.g., “Bank_Account[2]” may represent the value of the “Bank_Account” variable two time slices ago).

In accordance with one embodiment, each variable 185 has three attributes: name, type and priority. As shown in FIG. 4, the name of a variable 185 may be displayed near the left side of a variables editor 184 page. In one embodiment, a name having spaces will be surrounded by single quotes when used in a specification 155. The “type” attribute of a variable 185 is used to identify both the category (e.g., scalar, account and time series) and the valid range of the variable 185. The priority of a variable 185 is used to communicate information about the variable 185 to downstream systems (e.g., pricing tool 380). As a particular example, certain account variables 185 may need to be updated regularly when the pricing tool 380 is running a pricing simulation. As depicted in FIG. 4, a priority of “high” indicates that downstream systems are to update the value of the variable 185 for all states of the world.

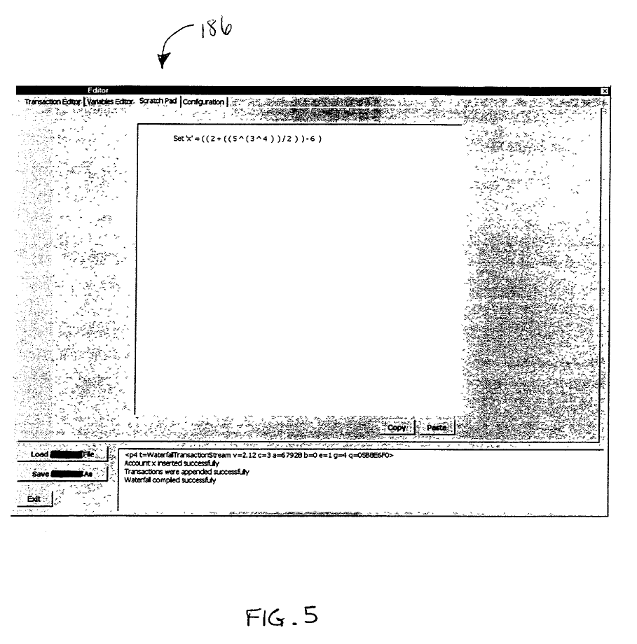

FIG. 5 depicts a portion of a scratch pad 186 page generated by the visual editor 180 of one embodiment of the present invention. A user 20 may interact with such a scratch pad 186 to view how the compiler 162 may interpret a particular line of a specification 155. For example, a scratch pad 186 may display the way a complex expression written without parentheses will be interpreted by the compiler 162.

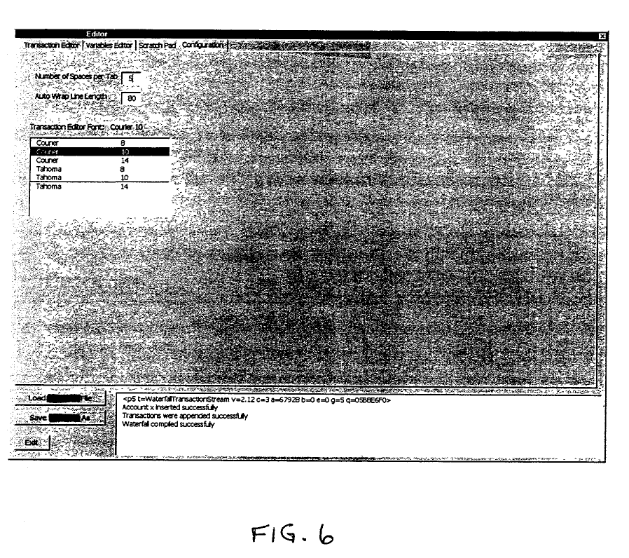

FIG. 6 depicts a portion of a configuration manager 188 page generated by the visual editor 180 of one embodiment of the present invention. A user 20 may interact with such a configuration manager 188 to create formatting defaults for the visual editor 180. For example, the user 20 may use the configuration manager 188 to define the number of spaces in a tab, as well as the font and font size to be used in the transaction editor 182.

C. Pricing Tool Interface 190

In one embodiment, the system 10 includes a pricing tool interface 190 that is capable of performing certain spreadsheet functions, and also allows a user 20 to perform a number of additional functions, including for example, loading a specification 155 into the spreadsheet, linking a compiled specification 155 with a pricing tool 380, defining the initial value of all accounts and all values for variables 185 to be simulated by the pricing tool 380, defining the format of the output of the pricing tool 380 (e.g., which accounts to display), displaying the output from the pricing tool 380 in a detailed format (e.g., value of all accounts after running the specification 155 a predetermined number of times), and debugging the specification (e.g., for any given date, display the value of all accounts prior to and after each statement or expression of the specification 155). In such an embodiment, the pricing tool interface 190 is a software application residing and running on a local computer 100, and in communication with a pricing tool 380 residing and running on a simulation computer 300.

D. Network 200

In the embodiment depicted in FIG. 1, a network 200 may be a local area network (LAN). Although the network 200 of the embodiment shown in FIG. 1 is a single LAN, in alternative embodiments, connections between local computers 100-1 to 100-N, between a local computer 100 and a simulation computer 300, and between simulation computers 300-1 to 300-N maybe of different types, including a connection over a telephone line, a direct connection, an Internet, a wide area network (WAN), an intranet or other network or combination of the aforementioned connections that is capable of communicating data between hardware and/or software devices. In such an embodiment, more than one local computer 100-1 to 100-N at a time may communicate with a particular simulation computer 300, and vice versa, over the network 200.

In one embodiment, some communications over the network 200 may be accomplished using the XML/HTTP protocol. However, such communication may also be accomplished using a number of other communication protocols, including single object access protocol (SOAP), XMLRPC, transfer control protocol/internet protocol (TCP/IP), file transfer protocol (FTP), or another suitable protocol or combination of protocols.

Using the network 200, a local computer 100 may request information from a simulation computer 300 by sending a hypertext transfer protocol (HTTP) request. For example, a local computer 100 shown in FIG. 2 may request access to a simulation computer 300 to obtain results from a pricing simulation. In this example, when the local computer 100 contacts the simulation computer 300, the local computer 100 asks the simulation computer 300 for information (e.g., a file of pricing results) built with a compatible language. After processing the HTTP request, the simulation computer 300 sends the requested information to the local computer 100 in the form of an HTTP response. Software 160 running on the local computer 100, such as the pricing tool interface 190, then interprets the information sent by the simulation computer 300 and provides it to the user 20 (e.g., displays it on an output device 140 such as a computer monitor or screen). In one embodiment, all communications between a local computer 100 and a simulation computer 300 are secure and involve an authentication process before access to the simulation computer 300 is granted. Such security may be achieved by using a secure protocol (e.g., secure socket layer (SSL)).

E. Simulation Computer 300

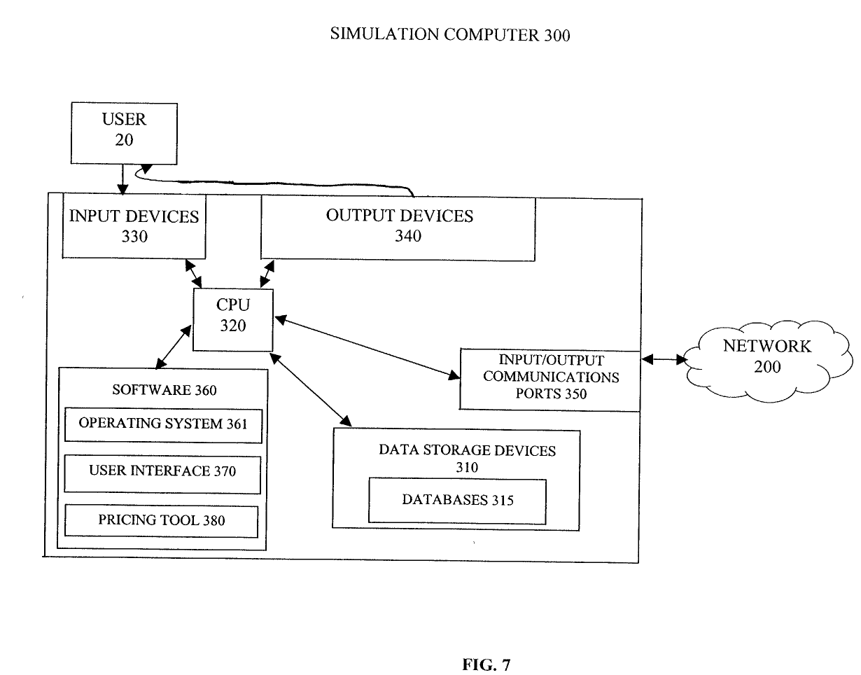

In the embodiment depicted in FIGS. 1 and 7, each simulation computer 300 generally includes one or more data storage devices 310, having one or more databases 315 defined therein, a central processing unit (CPU) 320, one or more input devices 330, one or more output devices 340, input/output (I/O) communications ports 350, and other hardware components (not shown) which facilitate performance of functions of the system 10 as described herein. In one embodiment, the hardware devices of a simulation computer 300 are in communication with one another by a shared data bus and/or by dedicated connections (not shown). In addition, a number of software components 360 run on each simulation computer 300.

A data storage device 310 of one embodiment includes one or more hard disk drives. However, it is to be understood that data storage devices 310 such as RAM, ROM, CD-ROM, DVD-ROM, floppy disk-drive or combinations thereof may also be included in the embodiment shown in FIG. 7, or in certain other appropriate embodiments. The input device(s) 330 (e.g., keyboard, pointing/selecting device such as a mouse, touch pad or track ball, floppy disk-drive, scanner and/or touch screen interface) enable a user 20 to provide information and instructions for storage in the simulation computer 300 and use in operation of the system 10. The output devices 340 (e.g., printer, display device, floppy disk-drive and/or computer monitor) enable a user 20 to receive, for further manipulation and/or storage, information generated using the system 10. The I/O communications ports 350 are serial and parallel, and are configured to include multiple communications channels for simultaneous connections. The software components 360 may include an operating system 361 (e.g., Linux, Unix, Microsoft Windows NT), one or more user interfaces 370, and a pricing tool 380.

In one embodiment, the simulation computers 300-1 to 300-N need not be identical. A simulation computer 300 of one embodiment may be, for example, a shared memory multiprocessor machine made by Sun Microsystems configured to run programs created using the Smalltalk programming language. Another simulation computer 300-2 of this embodiment may be an IBM machine running programs created using the C programming language. Yet another simulation computer 300-3 of the embodiment may be an SGI machine running programs using the C++ and/or Java programming languages.

II. Method Embodiments of the Invention

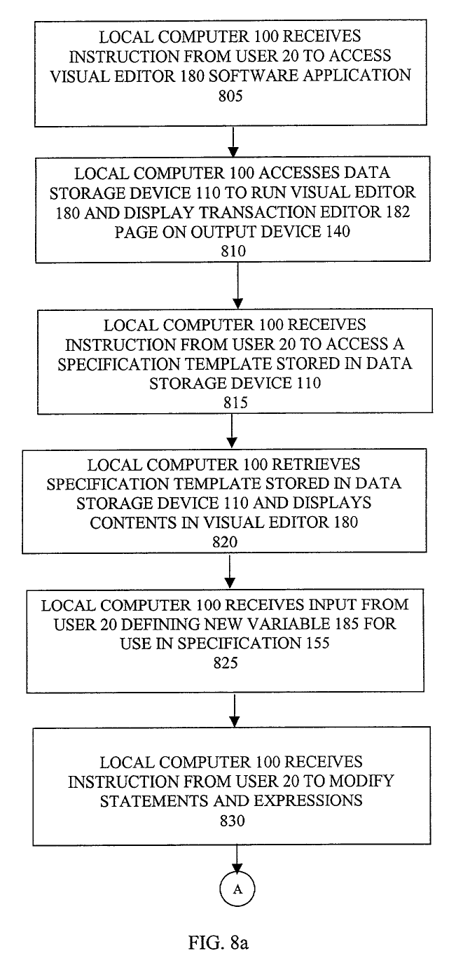

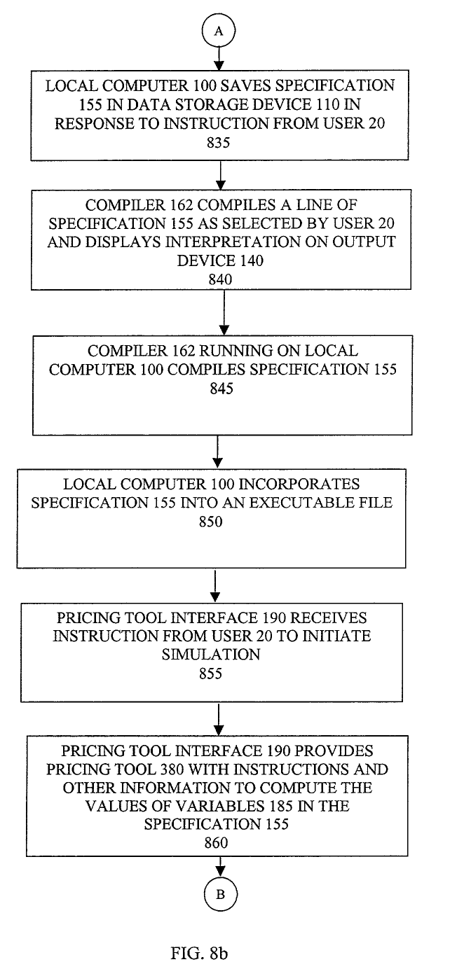

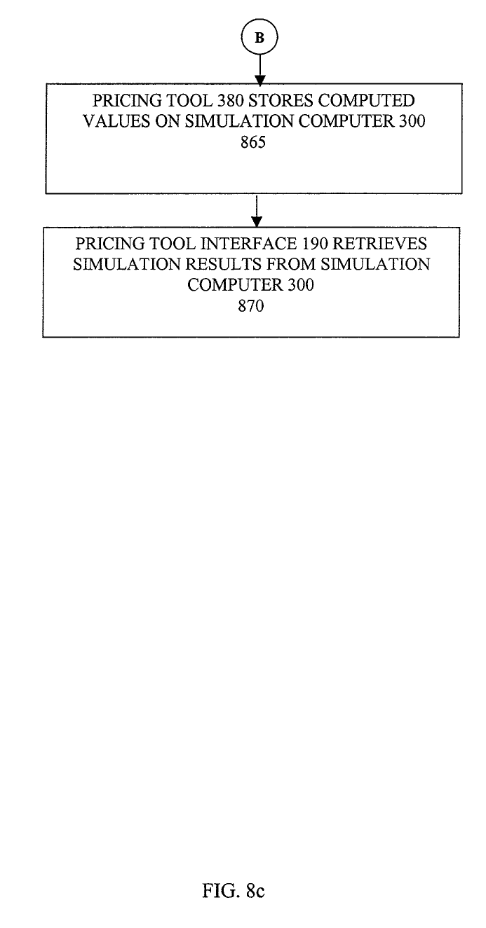

Having described the structure and functional implementation of certain aspects of embodiments of the system 10 of one embodiment, the operation and use of certain embodiments of the system 10 will now be described with reference to FIGS. 8-10, and continuing reference to FIGS. 1-7.

A. Method of Creating a Specification for Use with a Pricing Tool

In one method embodiment of the present invention, a particular user 20-1 interacts with the system 10 to create a specification 155 in a contractual style language. The specification 155 consists of a sequential list of statements and expressions which, among other things, enable a user 20 to model path dependent values, such as account values.

FIG. 8 illustrates certain operations performed in one embodiment of a method of creating a specification. In this embodiment, the user 20 may open or otherwise access the visual editor 180 software application on a local computer 100 by using a mouse and/or keyboard 130 to select or identify the visual editor 180 (step 805). In response to the request from the user 20, the local computer 100 runs the visual editor 180 software, and initially displays on an output device 140 (e.g., computer monitor or screen) the transaction editor 182 page of the visual editor 180, as shown for example in FIG. 3 (step 810).

As a further part of this method embodiment, the user 20 may use an input device 130 to select the “Load File” field displayed on the transaction editor 182 page, and then request a specification 155 previously stored in the data storage device 110 of the local computer 100 (step 815). In accordance with the user's 20 request, the local computer 100 may retrieve the requested specification 155 from the storage device 110 and display the contents of the specification 155 in the visual editor 180 as a template for the user 20 (step 820).

Continuing with such a method embodiment, the user 20 may interact with a visual editor 180 in a number of ways to define a new specification 155 based on the template accessed from storage. For example, the user 20 may define new variables 185 to be used in a specification 155 by selecting the variables editor 184 page of the visual editor 180, and then entering a name for the variable 185, and specifying whether the new variable 185 is a scalar variable, account variable, or a time series variable (step 825). Upon selection of the transaction editor 182 page by the user 20, the visual editor 180 displays on an output device 140 the new variable 185 with other variables 185 toward the right side of the page.

As a further example of a user's 20 interaction with the visual editor 180, the user may modify (or create entirely anew) the sequential list of statements and expressions of the specification 155 (step 830). In accordance with one embodiment, the visual editor 180 may display a list of predefined statements and expressions written in a contractual style grammar toward the left side of the transaction editor 182 page. The user 20 may select a displayed statement or expression using an input device 130 (e.g., a mouse), which inserts the selected statement or expression into the sequential list displayed in the center panel 183 of the transaction editor 182 page. In this way, each statement or expression listed toward the left of the transaction editor 182 page may be considered a building block for a specification 155. In accordance with one embodiment, a user 20 may insert variables 185 into statements and expressions as necessary by using a mouse 130 to select a variable 185 displayed toward the right side of the screen (e.g., pointing to the variable 185 and clicking a button on a mouse 130). In one embodiment, the user 20 saves the specification 155 in the data storage device 110 of the local computer 100 by selecting the “Save As” field of the transaction editor 182 page (step 835).

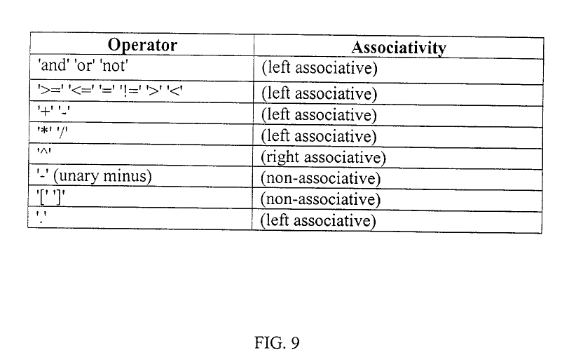

Once a statement or expression has been created, a user 20 may view how the compiler 162 will interpret it (step 840). A compiler 162 runs in connection with the visual editor 180. The visual editor 180 displays for the user 20 the way the compiler 162 will interpret a particular contractual style statement. For example, the contractual style statement “Transfer 0.2*x+y/2 from Account1 to Account2” may be interpreted by the compiler 162 as “Transfer ((0.2*x)+(y/2)) from Account1 to Account2.” The compiler 162 also provides information about syntax errors. In particular, according to one method embodiment of the present invention, the user 20 may highlight a particular line of the specification 155 and select the “Compile” field on the transaction editor 182 page. The visual editor 180 then displays the compiler's 162 interpretation of the line toward the bottom of the transaction editor 182 page and on the scratch pad 186 (shown in FIG. 5). In one embodiment, the compiler 162 uses the usual operator precedence and associatively found in mathematical and logical expressions. Specifically, starting from the lowest to the highest level of precedence, FIG. 9 depicts certain operators with an indication of their corresponding associativity. In such an example, selecting the statement “Set x=2+5\hat{ }3\hat{ }4/2−6” in a specification 155 displayed by the transaction editor 182, selecting the “Compile” field displayed by the transaction editor 182, and then displaying the scratch pad 186 page may produce the expression as displayed by the scratch pad 186 depicted in FIG. 5.

If the user 20 has not highlighted any particular line of the specification 155, selection of the “Compile” field on the transaction editor 182 page causes the compiler 162 to compile the entire specification 155, which evaluates the text of the specification 155 to ensure the contractual style grammar is in the format necessary for linking the specification 200 into an executable file for use with the pricing tool 380 (step 845). In an embodiment as shown in FIG. 3, the visual editor 180 displays the results of the compilation toward the bottom of a visual editor 180 screen. In the event of an error, the compiler 162 provides the visual editor 180 with information about the error for display to the user 20.

Once compiled, a specification 155 may be incorporated into an executable file for use with the pricing tool 380 to enable a simulation to be run using the specification 155 (step 850). When compiled and linked with a pricing simulation, such a specification 155 can be used to compute, for example, the payout of an instrument or the price of a security. In accordance with one method embodiment of the present invention, the user 20 need not generate the implementation itself, but need generate only the specification 155 of the structure of a particular financial transaction.

A pricing tool 380 may repeatedly set the state of the world and produce values for variables 185 of a specification 155. In one embodiment, the user 20 may interact with a pricing tool interface 190 to initiate a simulation (step 855). For example, the user 20 may prompts the pricing tool interface 190 to link a compiled specification 155 into an executable file for use with the pricing tool 380. The user 20 may also specify certain initial conditions for a particular simulation by entering those conditions into the pricing tool interface 190. Furthermore, the user 20 may specify the particular pricing tool 380 to be used. In one embodiment, the pricing tool interface 190 running on a particular local computer 100 then sends a request to a simulation computer 300 to compute the values of variables 185 contained in the specification 155 (e.g., compute the payout of an instrument as represented by a specification 155) (step 860).

Upon completion of a simulation, the results may be stored on the simulation computer 300 and accessed by a number of different users 20-1 to 20-N from a number of different local computers 20-1 to 20-N (step 865). In one embodiment, the results created by the pricing tool 380 are made available by the simulation computer 300 for retrieval by the local computer 100 and subsequent display by the pricing tool interface (step 870).

B. Method of Providing Information About a Financial Transaction

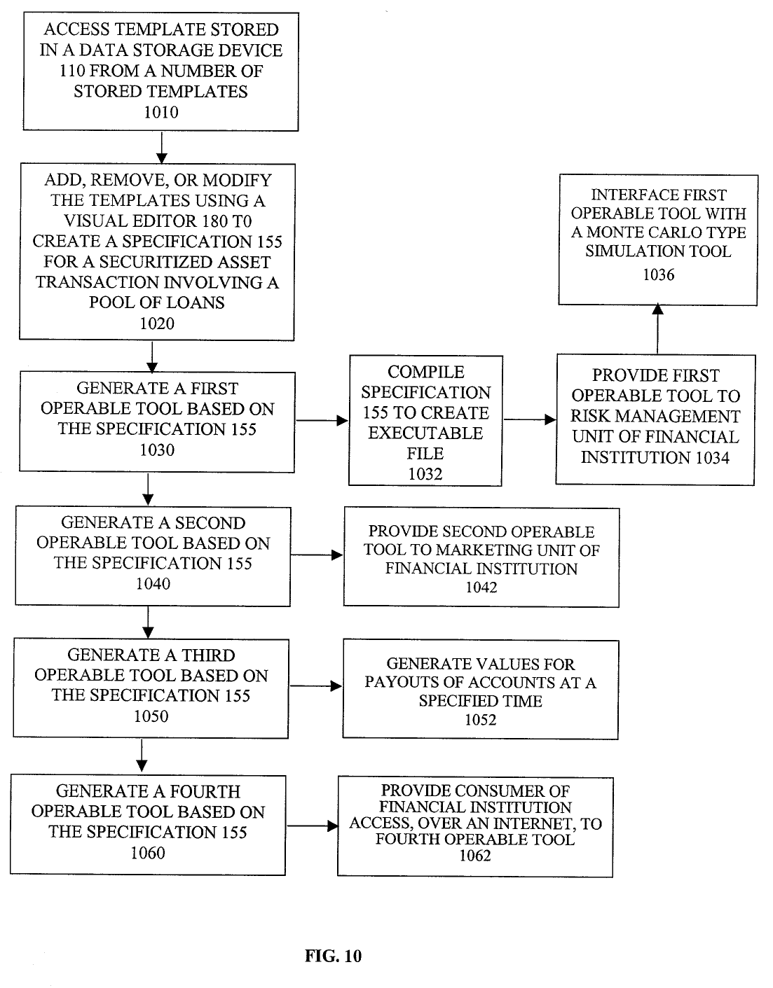

FIG. 10 illustrates certain operations performed in one embodiment of a method of providing information about a financial transaction for use by a number of users 20-1 to 20-N. As shown in FIG. 10, a user 20 may interact with a visual editor 180 and other necessary portions of the system 10 to create a specification 155. In one embodiment, the specification 155 may be created by first accessing a specification 155 stored in the data storage device 110 of the local computer (step 1005). The data storage device 110 may contain an electronic copy of specifications 155-1 to 155-N created previously using the visual editor as described above, or created in another manner. The retrieved specification 155 may then provide a template to create the new specification 155 (step 1010). In particular, the user 20 may interact with the visual editor 180 to remove one or more lines of the template specification, add one or more lines to the template specification, and/or change one or more lines of the template specification in the manner discussed above (step 1020).

Once the new specification 155 has been created, it may be used to generate a variety of different types of tools (steps 1030-1062). For example, a first operable tool based on the specification 155 may be generated for use by a user 20-1 in a risk management unit of a financial institution (step 1030). In such an example, the specification 155 may be compiled into an executable computer file (step 1032) for use with a pricing tool 380 to ascertain how the instrument or transaction modeled by the specification 155 may perform for various states of the world (steps 1034-1036). In a another example, a second operable tool based on the specification 155 may be generated for use by a user 20-2 performing a marketing function for a financial institution (step 1040). In such an example, the specification may be used to provide potential purchasers of instruments contained in the specification with information about returns on investment in an instrument. As yet another example, a third operable tool based on the specification 155 may be generated for use by a user 20-3 in the role of trustee for a financial institution (step 1050). In such an example, the specification 155 may be used to compute specific cash flows to be paid on a particular day based on the performance of an instrument represented by the specification 155 (steps 1052). As a further example, a fourth operable tool based on the specification 155 may be generated for use by a user 20-4 outside the financial institution, such as an actual or potential customer of the institution (step 1060). In such an example, the specification 155 maybe made accessible to the user 20-4 over an internet connection to enable the user 20-4 to evaluate the financial transaction represented by the specification 155 (step 1062).

Although illustrative embodiments and examples have been shown and described herein in detail, it should be noted and will be appreciated by those skilled in the art that there may be numerous variations and other embodiments which may be equivalent to those explicitly shown and described. For example, the scope of the present invention is not necessarily limited in all cases to execution of the aforementioned steps in the order discussed. Unless otherwise specifically stated, the terms and expressions have been used herein as terms and expressions of description, not of limitation. Accordingly, the invention is not to be limited by the specific illustrated and described embodiments (or the terms or expressions used to describe them) but only by the scope of the appended claims.

We claim:

1. A method of providing information about a financial transaction to a plurality of functional units of a financial institution, said method comprising:
assembling a specification for said financial transaction, said assembling comprising:
obtaining data descriptive of a transaction template from an electronic storage medium, said electronic storage medium comprising data descriptive of a plurality of pre-defined transaction templates, each of said transaction templates comprising a sequential list of instructions, at least one of said instructions comprising a financial transaction term in a contractual style grammar, each of said instructions comprising a variable corresponding to an account; and
using a computer system to perform at least one of the following group of actions:
removing at least one of said instructions from said sequential list;
adding an instruction to said sequential list; and
modifying at least one of said instructions; and
generating, based on said specification, a plurality of operable tools, each of said tools adapted for use by a different functional unit of said plurality of functional units of said financial institution.

2. The method of claim 1, wherein said financial transaction comprises a securitized asset transaction.

3. The method of claim 2, wherein said securitized asset transaction comprises a pool of loans.

4. The method of claim 1, further comprising storing data descriptive of said specification in said electronic storage medium as a transaction template of said plurality of transaction templates.

5. The method of claim 1, wherein said financial transaction term comprises a transfer statement.

6. The method of claim 1, wherein one of said functional units of said financial institution comprises a marketing function.

7. The method of claim 1, wherein one of said functional units of said financial institution comprises a risk management function.

8. The method of claim 1, wherein one of said functional units of said financial institution comprises a trustee function.

9. The method of claim 1, further comprising generating, based on said specification, an operable tool for use by a user other than said financial institution.

10. The method of claim 9, wherein said user comprises a customer of said financial institution.

11. The method of claim 9, further comprising providing access over a network to at least one of said operable tools.

12. The method of claim 11, wherein said network comprises an internet.

13. The method of claim 1, wherein said account is of a type selected from the group consisting of an investor account, a financial institution account and a portfolio manager account.

14. The method of claim 1, further comprising compiling said specification to create a computer code.

15. The method of claim 1, further comprising generating a value for said account using at least one of said plurality of operable tools.

16. The method of claim 15, wherein said generating a value for said account comprises interfacing at least one of said plurality of operable tools with a pricing tool.

17. The method of claim 16, wherein said pricing tool comprises a monte carlo model simulation tool.

18. The method of claim 1, further comprising generating, based on a subset of said instructions of said specification, an intermediate value for at least one of said accounts using at least one of said operable tools

19. The method of claim 1, wherein said computer system comprises a graphical user interface viewable on a display device.

20. The method of claim 19, wherein said graphical user interface comprises a visual editor comprising a viewable field displaying at least a portion of said transaction template.

21. A system for providing information about a financial transaction to a plurality of functional units of a financial institution, said system comprising:
a storage medium comprising data descriptive of a plurality of pre-defined transaction templates, each of said transaction templates comprising a sequential list of instructions, at least one of said instructions comprising a financial transaction term in a contractual style grammar, each of said instructions comprising a variable corresponding to an account; and
a processor in communication with said storage medium, said processor configured:
to assemble a specification for said financial transaction by:
obtaining data descriptive of a transaction template from said storage medium; and
performing at least one of the following group of actions:
removing at least one of said instructions from said sequential list;
adding an instruction to said sequential list; and
modifying at least one of said instructions; and
to generate, based on said specification, a plurality of operable tools, each of said tools for use by a different functional unit of said plurality of functional units of said financial institution.

22. The system of claim 21, wherein said financial transaction comprises a securitized asset transaction.

23. The system of claim 22, wherein said securitized asset transaction comprises a pool of loans.

24. The system of claim 21, wherein said processor is further configured to store data descriptive of said specification in said storage medium as a transaction template of said plurality of transaction templates.

25. The system of claim 21, wherein said financial transaction term comprises a transfer statement.

26. The system of claim 21, wherein one of said functional units of said financial institution comprises a marketing function.

27. The system of claim 21, wherein one of said functional units of said financial institution comprises a risk management function.

28. The system of claim 21, wherein one of said functional units of said financial institution comprises a trustee function.

29. The system of claim 21, wherein said processor is further configured to generate, based on said specification, an operable tool for use by a user other than said financial institution.

30. The system of claim 29, wherein said user comprises a customer of said financial institution.

31. The system of claim 29, wherein said processor is further configured to provide access over a network to at least one of said operable tools.

32. The system of claim 31, wherein said network comprises an internet.

33. The system of claim 21, wherein said account is of a type selected from the group consisting of an investor account, a financial institution account and a portfolio manager account.

34. The system of claim 21, wherein said processor is further configured to compile said specification to create a computer code.

35. The system of claim 21, wherein said processor is further configured to generate a value for said account using at least one of said plurality of operable tools.

36. The system of claim 35, wherein said processor is further configured to interface at least one of said plurality of operable tools with a pricing tool to generate a value for said account.

37. The system of claim 36, wherein said pricing tool comprises a monte carlo model simulation tool.

38. The system of claim 21, wherein said processor is further configured to generate, based on a subset of said instructions of said specification, an intermediate value for at least one of said accounts using at least one of said operable tools

39. The system of claim 21, further comprising a graphical user interface viewable on a display device.

40. The system of claim 39, wherein said graphical user interface comprises a visual editor comprising a viewable field displaying at least a portion of said transaction template.

41. A system for providing information about a financial transaction to a plurality of functional units of a financial institution, said system comprising:
means for assembling a specification for said financial transaction, said means for assembling comprising:
means for obtaining data descriptive of a transaction template from an electronic storage medium, said electronic storage medium comprising data descriptive of a plurality of pre-defined transaction templates, each of said transaction templates comprising a sequential list of instructions, at least one of said instructions comprising a financial transaction term in a contractual style grammar, each of said instructions comprising a variable corresponding to an account; and
means for performing at least one of the following group of actions:
removing at least one of said instructions from said sequential list;
adding an instruction to said sequential list; and
modifying at least one of said instructions; and
means for generating, based on said specification, a plurality of operable tools, each of said tools adapted for use by a different functional unit of said plurality of functional units of said financial institution.

42. The system of claim 41, wherein said financial transaction comprises a securitized asset transaction.

43. The system of claim 42, wherein said securitized asset transaction comprises a pool of loans.

44. The system of claim 41, further comprising means for storing data descriptive of said specification in said electronic storage medium as a transaction template of said plurality of transaction templates.

45. The system of claim 41, wherein said financial transaction term comprises a transfer statement.

46. The system of claim 41, wherein one of said functional units of said financial institution comprises a marketing function.

47. The system of claim 41, wherein one of said functional units of said financial institution comprises a risk management function.

48. The system of claim 41, wherein one of said functional units of said financial institution comprises a trustee function.

49. The system of claim 41, further comprising means for generating, based on said specification, an operable tool for use by a user other than said financial institution.

50. The system of claim 49, wherein said user comprises a customer of said financial institution.

51. The system of claim 49, further comprising means for accessing over a network to at least one of said operable tools.

52. The system of claim 51, wherein said network comprises an internet.

53. The system of claim 51, wherein said account is of a type selected from the group consisting of an investor account, a financial institution account and a portfolio manager account.

54. The system of claim 51, further comprising means for compiling said specification to create a computer code.

55. The system of claim 51, further comprising means for generating a value for said account using at least one of said plurality of operable tools.

56. The system of claim 55, wherein said generating a value for said account comprises interfacing at least one of said plurality of operable tools with a pricing tool.

57. The system of claim 56, wherein said pricing tool comprises a monte carlo model simulation tool.

58. The system of claim 41, further comprising means for generating, based on a subset of said instructions of said specification, an intermediate value for at least one of said accounts using at least one of said operable tools

59. The system of claim 41, further comprising a graphical user interface viewable on a display device.

60. The system of claim 59, wherein said graphical user interface comprises a visual editor comprising a viewable field displaying at least a portion of said transaction template.
